(19) United States
(12) Patent Application Publication
(10) Pub. No.: US 2019/0134905 A1
(43) Pub. Date: May 9, 2019

(54) MULTI-PART MATERIAL MIXING AND EXTRUSION FOR THREE-DIMENSIONAL (3D) PRINTING

(71) Applicant: STRUCTUR3D PRINTING INCORPORATED, Kitchener (CA)

(72) Inventors: Charles MIRE, Waterloo (CA); Andrew FINKLE, Kitchener (CA); Amir SOLOWIEJCZYK, Cambridge (CA)

(21) Appl. No.: 16/143,751

(22) Filed: Sep. 27, 2018

Related U.S. Application Data
(60) Provisional application No. 62/565,792, filed on Sep. 29, 2017.

(51) Int. Cl. B29C 64/314; B33Y 10/00; B33Y 30/00; B33Y 50/02; B29C 64/106; B29C 64/209; B29C 64/393; B33Y 40/00

(52) U.S. Cl. CPC B29C 64/314; B33Y 10/00; B33Y 30/00; B33Y 40/00; B29C 64/106; B29C 64/209; B29C 64/393; B33Y 50/02

(57) ABSTRACT

There is provided a system, apparatus, and method for extruding and mixing materials for three-dimensional printing using a three-dimensional printing device. The system includes: one or more extruders each adapted to receive and hold one or more syringes or cartridges, the syringes or cartridges containing extrudable material; a flexible tubing connectable to the syringes or cartridges received by the one or more extruders, an opposite end of the tubing mountable to an extrusion nozzle for extruding the extrudable material for three-dimensional printing; and a logic controller configured to control the flow of the extrudable material from the one or more extruders to a material mixing apparatus mounted on the three-dimensional printing device, the logic controller controlling the mixing of the extrudable material from the one or more syringes or cartridges.

### TECHNICAL FIELD

The present invention relates generally to the field of three-dimensional (3D) printing, and more particularly to a system, apparatus and method for extruding and mixing materials for three-dimensional printing using a three-dimensional printing device.

### BACKGROUND

In recent years, 3D printing has seen rapid growth as new processes are developed for additive manufacturing of 3D objects, whereby a 3D object of virtually any shape can be formed by adding successive layers of materials. This has allowed the development of new manufacturing processes such as rapid prototyping, and manufacturing of custom parts or replacement parts.

Common forms of additive processes include extrusion deposition, granular materials binding, lamination, and photopolymerization. With extrusion deposition, small beads of material are extruded from a nozzle to be fused to material that has already been laid down. Common types of materials used in extrusion deposition include thermoplastics and metals, typically supplied as filaments or wire that is unreeled and melted just prior to extrusion through a nozzle head. By extruding successive layers of beads of material through a nozzle under the control of one or more controller driven motors, it is possible to form articles with highly complex shapes that have heretofore not been possible, or prohibitively expensive to manufacture.

While there are now many 3D printing devices commercially available for 3D printing, the cost of the 3D printing devices has remained prohibitively high. As well, the types of materials that can be used for 3D printing has been limited by the extruder designs that have been heretofore available. Furthermore, the ability to mix multiple materials and control stimuli during material mixing, extrusion, and post-processing in 3D printing remains a challenge.

### SUMMARY

In an aspect, there is provided a system for mixing and extruding extrudable material for three-dimensional printing using a three-dimensional printing device, comprising: one or more extruders each adapted to receive one or more cartridges, the one or more cartridges containing extrudable material; a flexible tubing connectable to the one or more cartridges received by the one or more extruders, an opposite end of the flexible tubing mountable to an extrusion nozzle for extruding the extrudable material for three-dimensional printing; and one or more controllers configured to control flow of the extrudable material from the one or more extruders to a material mixing apparatus mounted on the three-dimensional printing device, the one or more controllers in communication with the material mixing apparatus to control mixing of the extrudable material from each of the one or more cartridges.

In a particular case, the system further comprising one or more valves mechanically interfacing with the flexible tubing and a valve controller interfaced with the one or more controllers and configured to direct the one or more valves to control flow of the extrudable material through the flexible tubing.

In another case, the one or more controllers controls the mixing of the extrudable material from each of the one or more cartridges at dynamically controlled mixing ratios during a same three-dimensional printing operation.

In yet another case, the system further comprising one or more heating elements associated with at least one of the one or more extruders and the flexible tubing, each of the heating elements apply heat to the extrudable material to affect a physical change in the extrudable material as directed by the one or more controllers.

In yet another case, the one or more controllers direct the heating elements dynamically to generate a dynamic temperature profile on the extrudable material during a same three-dimensional printing operation.

In yet another case, the system further comprising a post-extrusion device to affect a physical change in the extrudable material after it has been extruded, the post-extrusion device controlled by the one or more controllers.

In yet another case, the post-extrusion device comprises an ultra-violet (UV) light source to cure extruded material using UV radiation, the one or more controllers controlling at least one of the pulse or intensity of the UV radiation.

In yet another case, the one or more controllers dynamically control the curing of the extruded material during a same three-dimensional printing operation

In yet another case, the one or more controllers control the mixing of the extrudable material from each of the one or more cartridges at dynamically controlled mixing ratios during a same three-dimensional printing operation prior to extrusion.

In yet another case, a feedback signal is used by the one or more controllers to automatically regulate the extruding, the mixing, and the three-dimensional printing of the extrudable material.

In another aspect, there is provided a method for mixing and extruding extrudable material for three-dimensional printing, the method comprising: receiving one or more cartridges, the one or more cartridges containing extrudable material; passing the extrudable material from each of the one or more cartridges to one or more extrusion nozzles for three-dimensional printing; controlling mixing of the extrudable material from each of the one or more cartridges by controlling flow of the extrudable material.

In a particular case, the method further comprising controlling flow of the extrudable material by controlling one or more valves between each of the cartridges and the one or more extrusion nozzles.

In another case, controlling the mixing of the extrudable material from each of the one or more cartridges comprises dynamically controlling mixing ratios during a same three-dimensional printing operation.

In yet another case, the method further comprising applying heat to the extrudable material to affect a physical or chemical change in the extrudable material prior to extrusion.

In yet another case, applying the heat comprises dynamically applying heat to generate a dynamic temperature profile on the extrudable material during a same three-dimensional printing operation.

In yet another case, the method further comprising affecting a physical change in the extrudable material after it has been extruded.

In yet another case, the physical or chemical change is affected by curing the extruded material by subjecting the extruded material to ultra-violet (UV) radiation and controlling at least one of the pulse or intensity of the UV radiation.

In yet another case, subjecting the extruded material to UV radiation comprises dynamically controlling the curing of the extruded material during a same three-dimensional printing operation.

In yet another case, the method further comprising controlling the mixing of the extrudable material from each of the one or more cartridges at dynamically controlled mixing ratios during a same three-dimensional printing operation prior to extrusion.

In yet another case, the method further comprising using a feedback signal to automatically regulate the extruding, the mixing, and the three-dimensional printing of the extrudable material.

These and other embodiments are contemplated and described herein. It will be appreciated that the foregoing summary sets out representative aspects of various embodiments to assist skilled readers in understanding the following detailed description.

### DESCRIPTION OF THE DRAWINGS

A greater understanding of the embodiments will be had with reference to the Figures, in which:

FIG. 1 shows an illustrative example of an apparatus in accordance with an embodiment;

FIG. 2 shows a schematic diagram of various components of the apparatus of FIG. 1;

FIG. 3 shows a schematic diagram of a chassis adapted to hold a plurality of extrusion nozzles connected by flexible tubing;

FIG. 4 shows an illustrative example of an apparatus in accordance with another embodiment;

FIG. 5 shows an illustrative example of an apparatus in accordance with yet another embodiment;

FIG. 6 shows a schematic block diagram of a computing device which may provide an operating embodiment in one or more embodiments;

FIG. 7 shows another illustrative example of an apparatus in accordance with another embodiment;

FIG. 8 shows a schematic diagram of a system in accordance with an embodiment; and

FIG. 9 shows a perspective view of an apparatus in accordance with another embodiment.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

It will be appreciated that for simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It will be appreciated that various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It will be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The present disclosure relates to a system, apparatus and method for extruding and mixing materials for three-dimensional printing using a three-dimensional printing device.

Illustrative embodiments of the apparatus, method, and system will be described in detail with reference to the figures.

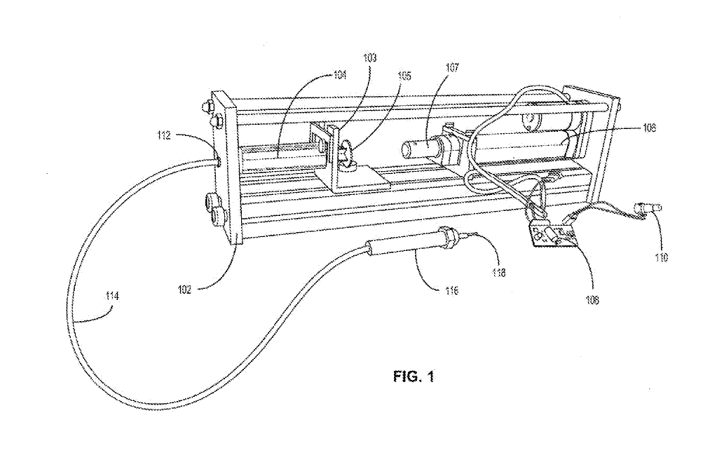

Referring to FIG. 1, shown is an illustrative example of an apparatus 100 in accordance with an embodiment. As shown, the apparatus 100 comprises a frame 102 adapted to receive a syringe or cartridge 104 with a depressible piston 105. The syringe or cartridge 104 can be, for example, a luer-lock syringe type, which can be securely mounted to the frame 102 by one or more brackets 103 mounted or mountable to the frame 102. At least one bracket 103 may be adjustably mounted to receive and secure the syringe or cartridge 104 of different lengths. Different sizes of brackets 103 may also be used to accommodate syringes or cartridges of different diameter or size, while still centering or properly positioning the syringe or cartridge 104 in the frame 102.

A flexible length of tubing 114 is connected to the tip of the syringe or cartridge 104. The flexible length of tubing 114 may be connected, for example, by a luer-lock connector 112 to secure the tip of the syringe or cartridge 104 to the length of flexible tubing 114. However, it will be appreciated that any other suitable means to connect the flexible length of tubing 114 to the syringe or cartridge 104 is possible.

The opposite end of the flexible length of tubing 114 is connected to a stylus 116 or mounting piece, and is provided with an extrusion nozzle tip 118. The flexible length of tubing 114 material may be chosen depending on the material to be extruded, and may be, for example, food grade plastic, or tubing coated with a non-stick material such as Teflon®. Although not essential, a transparent or translucent material for the flexible length of tubing 114 may be desirable such that extrusion of the material through the tubing can be visually confirmed.

Also included is a linear actuator motor 106 controlled by a motor control circuit 108. The linear actuator motor 106 is securely mounted to the frame 102 and substantially aligned with the piston 105 of the syringe or cartridge 104 to depress the piston 105. A potentiometer 110 can be used to control the amount of force to be applied by the linear actuator motor 106 depending on the type of material to be extruded. The motor control circuit 108 may be mounted on the frame 102 or mounted remote from the frame 102.

In operation, the syringe or cartridge 104 is pre-filled with material to be extruded, with the depressible piston 105 in an extended position. The linear actuator motor 106 is then controlled by an extruder logic module comprising the motor control circuit 108 to depress the piston 105 of the syringe or cartridge 106 with an extendable shaft or rod 107 in order to achieve a desired rate of extrusion of the material. As will be explained in further detail below, the rate of extrusion may also be controlled by a feedback signal from one or more sensors adapted to sense the rate of extrusion of material.

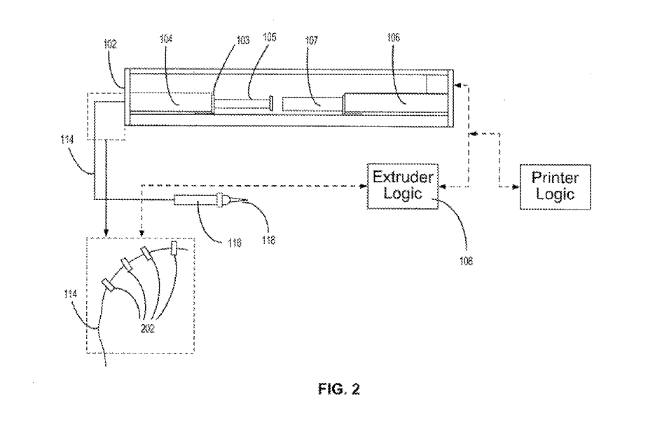

Now referring to FIG. 2, shown is a schematic diagram of various components of the apparatus of FIG. 1. As shown, the frame 102 securely holds a syringe or cartridge 104 with an extended, depressible piston 105 using one or more brackets 103 mounted to the frame 102. A linear actuation motor 106 is also mounted to the frame 102 using mounting brackets 103, and is positioned to drive the piston 105 with an extendable shaft or rod 107 under control of extruder logic 108.

In an embodiment, as the flow characteristics of different types of materials that may be extruded by the apparatus may vary widely, it is desirable to provide feedback to the extruder logic 108 to effectively control the speed and/or force of depression of the syringe or cartridge 104 such that the flow of extruded material is started, continues at a desired flow rate, or is stopped altogether. By way of example, a sensor array comprises a plurality of sensors 202 spaced apart along the flexible length of tubing 114 connecting the tip of the syringe or cartridge 104 to an extrusion nozzle 116. The sensors 202 may be spaced along a portion, or the entire flexible length of tubing 114 as may be required. In an embodiment, the sensors 202 may be optical sensor units incorporating a light source on one side of the tube and a light sensor on the opposite receiver side of the tube, whereby the sensor unit can sense when material has passed by. However, it will be appreciated that various other types of sensors 202 may also be used to determine when material has passed, or how quickly material is passing by.

As material passes through the tubing, the plurality of sensors 202 determines the rate of extrusion of the material, and provides a feedback signal to the extruder logic 108. Extruder logic 108 can operate with or without a user interface, such as a monitor or a digital display and corresponding input means such as a keyboard. For example, extruder logic 108 may be built using Arduino™ or a similar mass market control circuit, or a custom circuit specifically built for the apparatus. Extruder logic 108 is configured to receive data from the sensor array 202 and calculate a viscosity estimate of paste material being extruded. The viscosity estimate calculation is then determined in order to determine ideal extrusion parameters for driving the linear actuation motor 106 and its extendable rod 107.

In order to determine the viscosity estimate, the sensors 202 may detect the pressure and changes in the flow rate. In an embodiment, the linear actuator motor 106 can advance material at a defined pressure value, which can be verified via a recorded pressure value. These pressure variables can be used as determinants to estimate the viscosity value when other parameters of the apparatus 100 are known. By way of example, the material exits the cartridge 104 and enters the tubing 114, and the dimensions of the cartridge 104 and the smaller tubing 114 are known in advance. The time it takes for the material to travel through a defined length of tubing at a defined rate of pressure can then be used to estimate the viscosity of the material.

In addition to the sensor array 202, one or more force sensors (such as potentiometer 110) may be located at various pressure points on one or more of the frame 102, the syringe or cartridge 104, and the depressible piston 105, and the linear actuation motor 106 itself may also be used to determine the amount of force being applied to the syringe or cartridge 104, and to keep the linear actuation motor 106 within safe operating parameters.

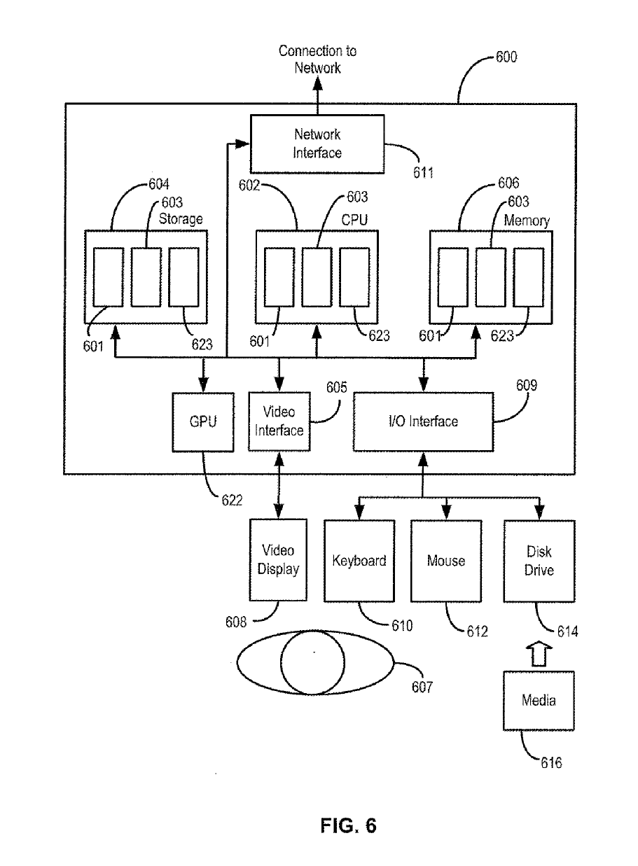

Using the extrusion logic 108, the feedback control can implement changes in the parameters automatically, or alternatively allow the user to make parameter changes via interaction with a user interface. As will be described further below, the extruder logic 108 may be connected to a computer device 600 (FIG. 6) to provide a full range of controls over all aspects of the operation of the apparatus, and to provide the user interface and various input means.

Advantageously, the parameters required for use with various materials may be recorded by the computing device 600, such that the user can build up a library of settings to be used with different extrudable materials during subsequent use of that material. In this manner, it is possible to effectively control the linear actuation motor 106 to be used to extrude a wide range of materials which may have different flow characteristics, and which may require different forces to be applied by the extrusion motor to achieve a desired flow rate.

In an embodiment, the stylus 116 can be hand-held for printing a 3D object by hand. The nozzle tip 118 provided in the stylus 116 can be secured by a luer lock mechanism. A manual on/off button located on the stylus 116 which controls the extrusion logic 108 allows the user easy control of the flow of extruded material when printing by hand.

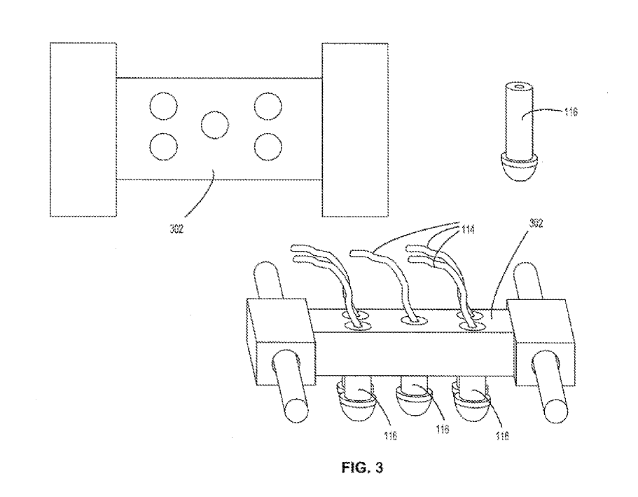

While it has been shown that the apparatus can be used as a standalone machine when connected to a stylus 116, which may be handheld, the stylus 116 may also be a mounting piece mounted on a chassis 302 as shown in FIG. 3. The chassis 302 may be connected to a 3D printing device for machine control via the 3D printing device (not shown). Thus, the 3D printing device may contain its own processor and logic to control the operation of the apparatus, in addition to controlling the movement of any chassis to which the stylus is mounted, as described in more detail below.

In an embodiment, the stylus 116 attached to the end of the flexible tubing 114 is mountable on a chassis 302 having one or more mounting locations, where each mounting location can receive a stylus 116 to mount an extrusion nozzle 118. As each stylus 116 is connected via a flexible length of tubing 114, it is possible to operate a plurality of nozzles 118 in parallel using the chassis 302, such that an extruded structure may be formed more quickly than using a single nozzle 118.

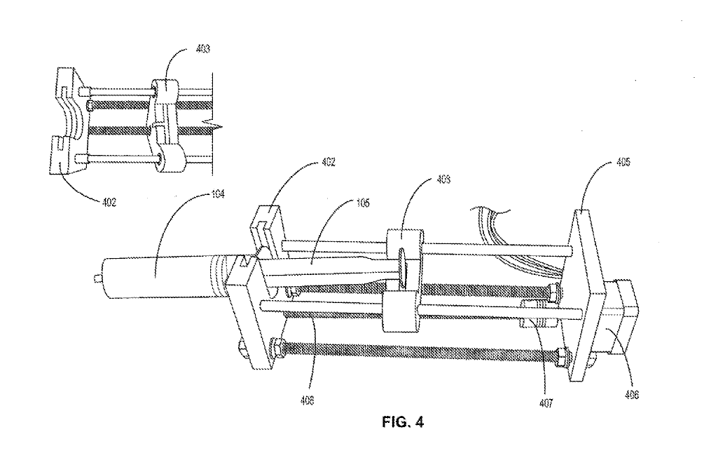

Now referring to FIG. 4, shown is an illustrative example of an apparatus in accordance with another embodiment. In this alternative embodiment, the barrel of the syringe or cartridge 104 is extending outside the frame and only its flange or end piece is received within a slot formed in an end piece 402 of the frame. The end piece 402 of the frame and the movable plunger gripper 403 may be made of metal, or alternatively a hard plastic material to reduce weight and the build cost of the material.

In an embodiment, the end of an extending plunger 105 of the syringe or cartridge 104 is received within a movable plunger gripper 403. The movable plunger gripper 403 itself may include a slot to receive a flange provided on the end of the extending plunger 105. The movable plunger gripper 403 is slidably mounted to a plurality of metal rods positioned to provide structural support to the frame. For example, as shown in FIG. 4, four metal rods may be fastened to two end pieces of the frame, where the first end piece 402 receives the flange of the syringe or cartridge 104, and the second end piece 405 mounts an extrusion motor 406. The movable plunger gripper 403 may include linear bearings to guide the movable plunger gripper 403 more smoothly along the plurality of rods.

In an embodiment, the movable plunger gripper 403 includes a threaded nut or Rampa™ insert 407 to engage and guide the movable plunger gripper 403 along the length of a threaded screw 408. The threaded screw 408 is coupled at one end to a shaft of extrusion motor 406. In an embodiment, the coupling may include a gearbox to generate sufficient torque using a smaller, less expensive motor than otherwise would be required for a direct drive extrusion motor.

When the extrusion motor threaded screw 408 rotates in a first direction, the movable plunger gripper 403 moves towards the first end piece 402 of the frame, causing the plunger 105 to move into the barrel of the syringe or cartridge 104 and cause the material contained in the syringe or cartridge barrel 104 to be squeezed out. When the extrusion motor threaded screw 408 rotates in a second, opposite direction, the movable plunger gripper 403 moves away from the first end piece 402 of the frame, and positions the movable plunger gripper 403 to receive the next syringe or cartridge filled with material with an extended plunger. Advantageously, by having the barrel of the syringe or cartridge 104 outside the frame, the frame can be made significantly smaller than the embodiment shown in FIG. 1.

Still referring to FIG. 4, in an embodiment, the apparatus may further include a barcode or chip reader positioned near the syringe or cartridge 104 to read a label on the syringe or cartridge 104. The label may provide, for example, information regarding the properties of the materials contained in the syringe or cartridge 104. This information may be used to set a motor speed suitable for the material, for example. In another embodiment, the information provided on the barcode label or chip provides instructions for preparing the materials prior to use. For example, the material may need to be pre-heated to a desired temperature prior to extrusion, and the information provided on the barcode label or chip may provide instructions for testing the temperature of the material prior to use, and heating the material with a heat source if necessary to a desired operating temperature. Thus, the information provided may also be used to operate one or more modules of the system.

In another embodiment, the movable plunger gripper 403 may further include a pressure sensor (e.g. potentiometer 110) to detect the back pressure applied by the material against the plunger 105. The pressure sensor may be utilized as feedback to control the extrusion motor 406 in real-time, to avoid undue pressure which may cause damage.

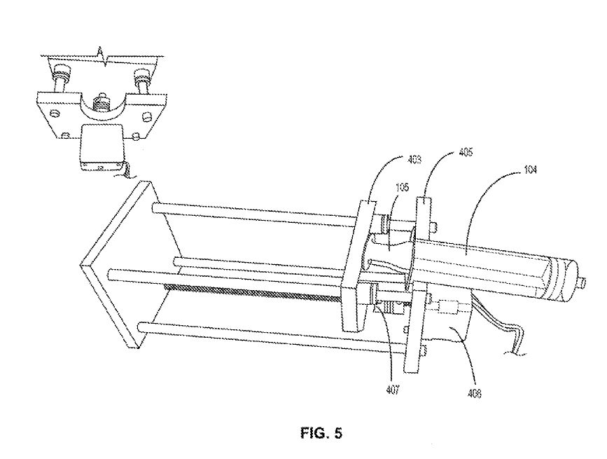

In yet another embodiment, the barrel of the syringe or cartridge 104 may receive a temperature sensor to detect the temperature of the material in the syringe or cartridge, which may determine how much pressure to apply to squeeze the material out. Now referring to FIG. 5, shown is another illustrative embodiment in which the motor is mounted on the same end piece 405 of the frame that receives the flange of the syringe or cartridge barrel. In this case, the extrusion motor 406 is shown mounted below the syringe or cartridge barrel when it is received in the frame end piece. This alternative configuration leaves the other end piece free of any motor mounted on the outside of the frame, allowing the size of the frame to be potentially even further reduced. Other features described with reference to FIG. 4 may also be included in FIG. 5.

These alternative embodiments shown and described in FIGS. 4 and 5 may significantly lower the manufacturing cost of a paste extruder in comparison to the embodiment shown in FIG. 1. With the barrel of the syringe or cartridge extending outside the frame, the size of the extruder can be made significantly smaller than the extruder shown in FIG. 1. These alternative embodiments also show the flexibility of the design arrangement and component placement for this extruder system.

FIG. 6 shows a schematic block diagram of a computer device controller, for example implemented on a computer device, which may be connected to the extruder logic 108 (see FIG. 2) described above to provide machine control. A suitably configured computer device, and associated communications networks, devices, software and firmware may provide a platform for enabling one or more embodiments as described above. By way of example, FIG. 6 shows a computer device 600 that may include a central processing unit (“CPU”) 602 connected to a storage unit 604 and to a random access memory 606. The CPU 602 may process an operating system 601, an application program 603, and data 623. The operating system 601, application program 603, and data 623 may be stored in storage unit 604 and loaded into memory 606, as may be required. Computer device 600 may further include a graphics processing unit (GPU) 622 which is operatively connected to CPU 602 and to memory 606 to offload intensive image processing calculations from CPU 602 and run these calculations in parallel with CPU 602. An operator 607 may interact with the computer device 600 using a video display 608 connected by a video interface 605, and various input/output devices such as a keyboard 610, a pointer 612, and storage 614 connected by an I/O interface 609. The pointer 612 may be configured to control movement of a cursor or pointer icon in the video display 608, and to operate various graphical user interface (GUI) controls appearing in the video display 608. The computer device 600 may form part of a network via a network interface 611, allowing the computer device 600 to communicate with other suitably configured data processing systems or circuits, such as the extrusion logic motor circuit of the apparatus described above. One or more different types of sensors 630 connected via a sensor interface 632 may be used to search for and sense input from various sources. The sensors 630 may be built directly into the computer device 600, or optionally configured as an attachment or accessory to the computer device 600. The sensors may also be provided on the apparatus of FIGS. 1 to 3, and the feedback signal may be received by the computer device 600 directly, or via the extruder logic 2).

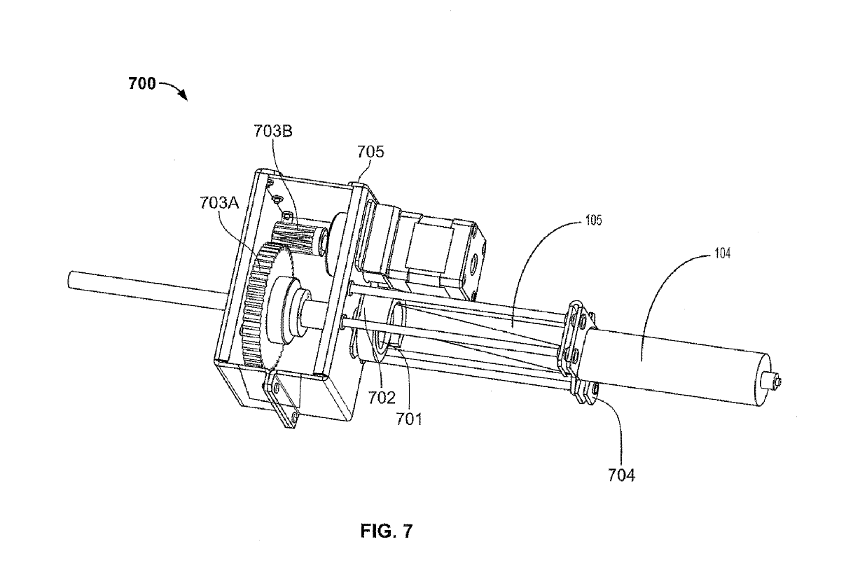

Now referring to FIG. 7, shown is another illustrative example of an apparatus 700 in accordance with another embodiment. In this example, the extruder now includes a minimal friction disk 701 positioned inside a syringe or cartridge cap at the end of the linear actuator in order to reduce possible rotational force against the syringe or cartridge plunger. A locking pin 702 may be used to connect the syringe or cartridge cap to the linear actuator.

In an embodiment, the apparatus 700 includes gearing 703A, 703B which may be optimized to apply an appropriate linear force against the piston 105 of the syringe or cartridge 104.

In an embodiment, a custom syringe or cartridge cradle 704 is provided, which cradle 704 is attached to support rods fixed at opposite ends to a frame 705. In order to provide sufficient strength for the apparatus, and the forces generated, the gear and motor frame 705 is preferably made of a metal. This embodiment further reduces cost and improves efficiency for production manufacturing.

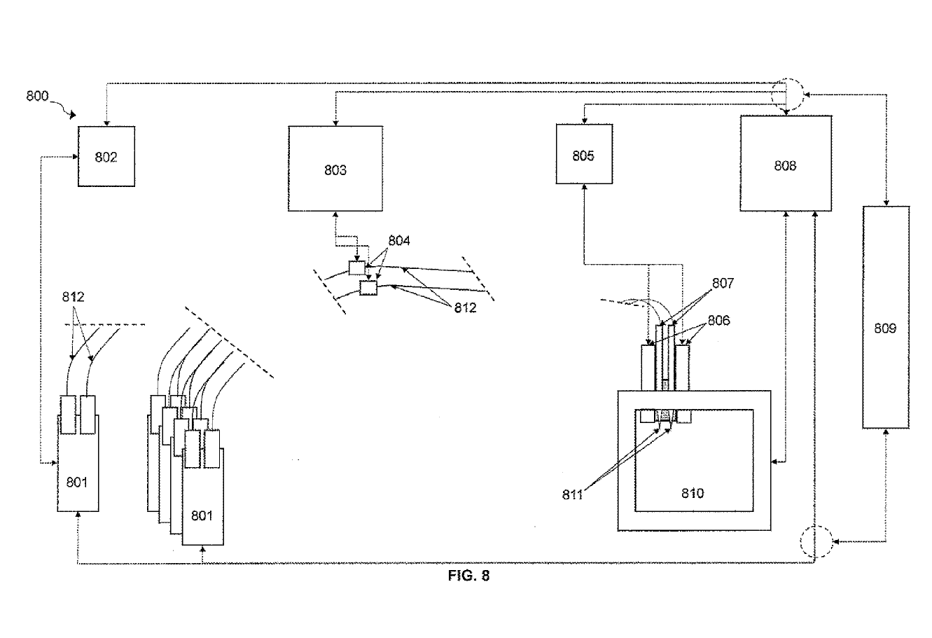

FIG. 8 illustrates an embodiment of a system 800 for extruding and mixing materials for three-dimensional printing, in accordance with an embodiment. The system 800 permits material mixing.

In this embodiment, the system 800 comprises an extruder 801, the extruder 801 having two or more syringes or cartridges mounted thereon. It will be appreciated that, as referred to herein, cartridges can refer to cartridges or syringes, and vice versa. In a particular case, the system 800 can include a plurality of extruders 801 arranged in an array and, for example, placed on opposite sides of a 3D printing device 810, or placed on one side of the 3D printing device 810. In a particular case, the extruders 801 can be physically separated from the 3D printing device 810, and connected by the tubing 812. In some cases, each extruder 801 can be located inside of a case, for example a box-shaped case, allowing the extruders 801 to stand freely from the 3D printing device 810. Material is extruded from the cartridges, via mechanical displacement, through flexible tubing 812 towards material mixing apparatuses 807 which are mounted on the 3D printing device 810. The tubing 812 may be conventional tubing or customized for the material's properties. The extruder 801 can be configured to have cartridges of different sizes mounted thereon, and therefore can be configured to accommodate different volumes of material. Multiple cartridges can be received by the extruder 801 in a similar manner to that shown in FIG. 7. In a particular case, the extruder 801 is a modified extruder apparatus 700 with small fittings that can be inserted or switched out to accommodate a given set of mixing ratios.

In an embodiment, the 3D printing device 810 uses the extrusion method of 3D printing, in which material is physically extruded through a nozzle or nozzles 811 onto a substrate. The nozzles 811 can have various shapes and designs, and/or can be customized to achieve certain desired material extrusion outputs.

The extrusion process is controlled by a logic controller 808 of the 3D printing device 810. In some cases, the logic controller 808 is located on the 3D printing device 810. In a particular case, the logic controller 808 comprises information for directing the 3D printing device 810, such as including appropriate firmware or software interfaces. The logic controller 808 can also direct connections to components of the system 800 such as temperature probes, heating elements, cooling fans, and stepper motors. In some cases, the extrusion process is controlled in conjunction with input received from an input/output interface 809. The input/output interface 809 can be in communication with a user interface or with another computing device over a network. The logic controller 808 receives and processes input commands to control components of the system 800 and, in some cases, one or more modules. Such modules can include, for example, a heating module to control the temperature of the cartridge and tubing, and an ultra-violet (UV) module for quickly curing a liquid material using UV light. The logic controller 808 also generates output signals, such as temperature readings from the 3D printing device 810, to a user interface that is part of the 3D printing device 810 and/or part of the input/output interface 809 (which can be part of the 3D printing device 810 or external to it). The input/output interface 809 allows for direct or remote user interaction to control the system 800 and peripherals. In some cases, a feedback loop may be established between the input/output interface 809, the logic controller 808, and the optional modules so as to automatically regulate the extrusion, mixing, and 3D printing of materials.

In some embodiments, the system 800 can further include sensors (not shown) that can detect changes in pressure and/or flow rate of the material to implement a feedback loop. In an embodiment, these changes (delta values) can be measured against predetermined baseline system settings for pressure and flow rate, and if the magnitude of the delta reaches a certain threshold, the system 800 can be configured to respond or feedback in a pre-defined manner. By way of example, if the sensors detect a sudden increase in pressure as material travels through portions of the system, this may indicate the material viscosity is too high at the bottleneck point. In this event, the logic controller 808 can direct heating of the material, as described herein, which can be used to lower the viscosity of the material to enhance flow. When the pressure feedback loop measures a reduction in the delta pressure value so as to correspond more closely to the baseline pressure setting, the logic controller 808 can maintain the conditions until the process is completed optimally.

The system 800 includes one or more material mixing apparatuses 807 that can be static, inline, or can be mechanical and controlled by a secondary controller 805 interfaced with the logic controller 808 and/or input/output interface 809. In an example, the secondary controller 805 receives instructions and parameters from the logic controller 808 and performs further calculations and programming procedures to directly control operation of the nozzles 811. The system 800 also includes a valve controller 803 for controlling a valve 804 that mechanically interfaces with the tubing 812. In some cases, the valve 804 can comprise an array of valves 804. Each of the valves 804 may be fully open, fully closed, or partially closed to govern the flow rate of the material, and therefore the mixing ratio for 3D printing. The valve controller 803 may be interfaced to the logic controller 808 and/or to the interface 809. In a particular case, the one or more valves 804 are connected in-line in the middle of the tubing 812, for example midway between the cartridges and the nozzles 811. In another example, the material mixing apparatuses 807 are mounted directly on a nozzle gantry on the 3D printing device 810.

In an embodiment, one of the material mixing apparatuses 807 can be an inline static mixer, which works by folding the materials an certain number of times to ensure thorough mixing before extrusion from the nozzle 811. The physical folds of the mixer can inhibit the flow of the material, in which case the sensor feedback loop, described herein, can be used to help control the flow rate of the material through the mixer. In some embodiments, the nozzles may not require any further control other than movement.

Using the secondary controller 805 and the valve controller 803, the system 800 can advantageously mix materials during 3D printing. As an example, the system 800 can advantageously produce a final output material comprising a combination of two or more parts, mixed at a specific ratio; for example 1:1, 1:5, or the like. As another example, the system 800 can be advantageously used to generate a desired chemical reaction; for example, combining each part of a two-part epoxy mixture at a specific ratio. As another example, the system 800 can be advantageously used to generate a desired physical reaction; for example, properly mixing additives in a carrying mix at a specific ratio. As another example, the system 800 can be advantageously used to coaxially or homogenously mix multiple materials into a 3D print.

As an example, the system 800 can be used to produce a material with varying thickness. The system 800, via the valve controller 803, would firstly extrude material at a 100% flow rate for several layers of a 3D print. Then, the system 800 would extrude several layers printed at a 30% flow rate, followed by several layers printed at a 60% flow rate. This example would achieve a final 3D print consisting of multiple layers of different thickness from the same extruded material.

As another example, the system 800 can be used to produce a material with dynamically controlled mixing ratios. The system 800, via the valve controller 803 and secondary controller 805, allows for dynamic control of the ratios governing the physical and chemical mixing of materials prior to the extrusion point. As an example, the system 800 could output a 1:1 ratio mixture of two materials, and then change this to a 1:5 ratio mixture during the same 3D print. Further, dynamically variable valves for mixing and flow control is not limited to two materials. Both the mixing ratios and flow rate for 3D printing can be independently controlled to achieve wide variance within a single 3D print. As an example, the system 800 can use seven materials consisting of two components of a silicone and five colours (Cyan, Magenta, Yellow, Key [Black], and White—known as “CMYKW”). The mixing and flow variability provided by the system 800 would allow for full colour silicone printing, with multiple colours all within a single 3D print.

In an embodiment of the system 800, a stimuli controller 802 can be used to interface with the logic controller 808 and with the input/output interface 809. The stimuli controller 802 controls heating elements associated with the extruder 801 and/or heating elements located along the length of the tubing 812 to control viscosity of the extrudable material. In some cases, the stimuli controller 802 can also govern inputs such as radiation, electricity, magnetic field, or ultra-sound. These inputs can be applied by the stimuli controller 802 prior to 3D printing in order to initiate a chemical or physical change in the material. In an example, the stimuli controller 802 can apply radiation to material stored in a cartridge that has a component which remains inert until being exposed to the radiation, after which point it modifies surrounding material to achieve a desired property.

In an embodiment, ultrasound can be used to maintain the dispersion and homogeneity of a particle-filled composite material. In an embodiment, radiation can be used to trigger localized reactions of a particle-filled composite where particles may disintegrate, leaving behind specific voids in the bulk structure.

Advantageously, using the stimuli controller 802 for materials extrusion processing allows, as an example, the system 800 to use heating or cooling to control the temperature of one or more material cartridges prior to mixing. As another example, using the stimuli controller 802 allows the system 800 to use heating or cooling to control the temperature of the final mixed materials just prior to 3D printing. As another example, using the stimuli controller 802 allows the system 800 to use a dynamic temperature profile, over time, to govern the 3D printing process.

In an example, when the sensor feedback loop determines the flow rate of a material is being reduced by physical constraints in the system 800, the material can be heated to improve the flow rate to predetermined values, as described herein. In this manner, the temperature is activated and maintained dynamically to ensure successful completion of the 3D printing process.

In an embodiment of the system 800, the secondary controller 805 can be used to govern a post-extrusion ultra-violet (UV) light curing device 806. In some cases, the secondary controller 805 can also govern other inputs and associated devices, such as radiation, magnetic field, or ultra-sound. These inputs are applied by the secondary controller 805 at the 3D print site to enact desired changes in the material during or after it has been printed; for example curing, or other physical or chemical changes in the material. In a particular case, the UV light curing device 806 consists of a light source, such as a UV bulb, and a main control box that controls the pulse or intensity of the light. In this particular case, a fibre cable leads to a series of focal lenses within a 5 cm long cylindrical enclosure (e.g., 1 cm in diameter) with an exit point where the light beam exits, the cylindrical enclosure being mounted near the nozzles 811 at an angle so as to align the light beam onto the printed material. In most cases, any material to which photo-reactive polymers can be added can be used with the ultraviolet curing process. By way of example, such materials include silicones, epoxies, and some nanoparticle composite materials.

Advantageously, using the secondary controller 805 to control post-printing processing allows, as an example, the system 800 to use ultra-violet (UV) or other radiation to control the curing or solidification of the final printed material. As another example, using the secondary controller 805 allows the system 800 to use ultra-violet (UV) or other radiation profile to govern the curing or solidification of the final printed material differently depending on the physical position of deposition of the material or depending on the time of deposition of the material.

Advantageously, the system 800 allows for a higher degree of customization in 3D printing than other approaches by, for example, controlling material mixing, controlling external stimuli during material mixing and extrusion, and controlling stimuli for post-printing processing. As an example, the system 800 allows for generating complex temperature profiles for various multi-part material formulations.

Advantageously, the system 800 allows for the dynamic control of UV light or other radiation. In this way, some parts of a 3D print can be fully cured with full power of the UV light or radiation source, while other parts of the 3D print can be only partially cured with minimal (or other value) power of the UV light or radiation source. In an example, the system 800 allows for the partially cured material to act as a temporary support at some sections of the overall 3D print, which can physically be removed later. Thus, the system 800 allows for complex designs that include features such as overhangs (printing over an air gap), as the partially cured material provides support for subsequent fully cured material. This aspect, when combined with the dynamic mixing aspect described above, can further be employed to achieve highly customized multi-material composite objects as a complete 3D print. As an example, four materials could be printed for a 3D print, where for the first few layers of the 3D print the mixing ratio is 1:1:0:0 with full UV light curing. Then, subsequent layers could be printed with the mixing ratio changed to 1:1:2:5 with full UV light curing. Thus, resulting in variable densities or hardnesses of the final 3D print. In another example, four materials could be printed with a mixing ratio of 0:0:1:2 with no UV light or radiation curing for several layers of a 3D print. Then, subsequent layers of the 3D print can have the mixing ratio of 1:3:0:0 with some other radiation curing. Then, subsequent final layers could go back to having the mixing ratio of 0:0:1:2 with no UV light or radiation curing.

In an example, the system 800 can be used to make a multi-material shoe or to make a wearable strain sensor that is ready-to-use straight from the printer with minimal or no further handling or assembly.

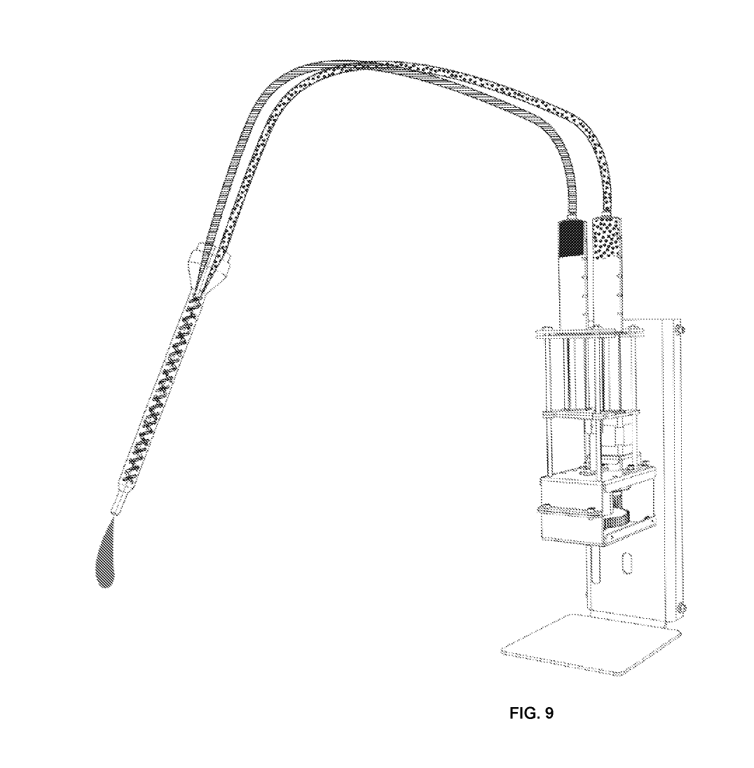

FIG. 9 illustrates another embodiment of the system 800, similar to the embodiment described with respect to FIG. 7. In this embodiment, the system 800 includes two cartridges on one extruder. The system 800 also includes a mixer element (a static inline mixer in this embodiment) and the manifold piece to join the tubing from the two cartridges to the mixer. In this case, the static inline mixer is a non-mechanical mixer; whereby the channels inside the mixer are designed to “fold” the two materials together from beginning to end. In further embodiments, the mixer could be an active mechanical mixer where the internal shaft of the mixer moves or rotates in order to mix the two (or more) materials.

While the embodiments of the system 800 describe multiple controllers, it is contemplated that some or all of the controllers may be combined; for example, having one of the controllers execute the functions of two or more controllers. It is also contemplated that each of the controllers comprise at least one processing unit and a memory storage.

While illustrative embodiments have been described above by way of example, it will be appreciated that various changes and modifications may be made without departing from the scope of the invention, which is defined by the following claims.

1. A system for mixing and extruding extrudable material for three-dimensional printing using a three-dimensional printing device, comprising:
one or more extruders each adapted to receive one or more cartridges, the one or more cartridges containing extrudable material;
a flexible tubing connectable to the one or more cartridges received by the one or more extruders, an opposite end of the flexible tubing mountable to an extrusion nozzle for extruding the extrudable material for three-dimensional printing; and
one or more controllers configured to control flow of the extrudable material from the one or more extruders to a material mixing apparatus mounted on the three-dimensional printing device, the one or more controllers in communication with the material mixing apparatus to control mixing of the extrudable material from each of the one or more cartridges.

2. The system of claim 1, further comprising one or more valves mechanically interfacing with the flexible tubing and in communication with the one or more controllers, the one or more controllers configured to direct the one or more valves to control flow of the extrudable material through the flexible tubing.

3. The system of claim 1, wherein the one or more controllers control the mixing of the extrudable material from each of the one or more cartridges at dynamically controlled mixing ratios during a same three-dimensional printing operation.

4. The system of claim 1, further comprising one or more heating elements associated with at least one of the one or more extruders and the flexible tubing, each of the heating elements apply heat to the extrudable material to affect a physical change in the extrudable material as directed by the one or more controllers.

5. The system of claim 4, wherein the one or more controllers direct the heating elements dynamically to generate a dynamic temperature profile on the extrudable material during a same three-dimensional printing operation.

6. The system of claim 1, further comprising a post-extrusion device to affect a physical change in the extrudable material after it has been extruded, the post-extrusion device controlled by the one or more controllers.

7. The system of claim 6, wherein the post-extrusion device comprises an ultra-violet (UV) light source to cure extruded material using UV radiation, the one or more controllers controlling at least one of the pulse or intensity of the UV radiation.

8. The system of claim 7, wherein the one or more controllers dynamically control the curing of the extruded material during a same three-dimensional printing operation

9. The system of claim 8, wherein the one or more controllers control the mixing of the extrudable material from each of the one or more cartridges at dynamically controlled mixing ratios during a same three-dimensional printing operation prior to extrusion.

10. The system of claim 1, wherein a feedback signal is used by the one or more controllers to automatically regulate the extruding, the mixing, and the three-dimensional printing of the extrudable material.

11. A method for mixing and extruding extrudable material for three-dimensional printing, the method comprising:
receiving one or more cartridges, the one or more cartridges containing extrudable material;
passing the extrudable material from each of the one or more cartridges to one or more extrusion nozzles for three-dimensional printing;
controlling mixing of the extrudable material from each of the one or more cartridges by controlling flow of the extrudable material.

12. The method of claim 11, further comprising controlling flow of the extrudable material by controlling one or more valves between each of the one or more cartridges and the one or more extrusion nozzles.

13. The method of claim 11, wherein controlling the mixing of the extrudable material from each of the one or more cartridges comprises dynamically controlling mixing ratios during a same three-dimensional printing operation.

14. The method of claim 11, further comprising applying heat to the extrudable material to affect a physical change in the extrudable material prior to extrusion.

15. The method of claim 14, wherein applying the heat comprises dynamically applying heat to generate a dynamic temperature profile on the extrudable material during a same three-dimensional printing operation.

16. The method of claim 1, further comprising affecting a physical change in the extrudable material after it has been extruded.

17. The method of claim 16, wherein the physical change is affected by curing the extruded material by subjecting the extruded material to ultra-violet (UV) radiation and controlling at least one of the pulse or intensity of the UV radiation.

18. The method of claim 17, wherein subjecting the extruded material to UV radiation comprises dynamically controlling the curing of the extruded material during a same three-dimensional printing operation.

19. The method of claim 18, further comprising controlling the mixing of the extrudable material from each of the one or more cartridges at dynamically controlled mixing ratios during a same three-dimensional printing operation prior to extrusion.

20. The method of claim 11, further comprising using a feedback signal to automatically regulate the extruding, the mixing, and the three-dimensional printing of the extrudable material.
